(19) United States
(12) Patent Application Publication
(10) Pub. No.: US 2024/0399293 A1
(43) Pub. Date: Dec. 5, 2024

(54) PROCESSING OF SULFUR SPECIES WITH DEEP EUTECTIC SOLVENTS OR IONIC LIQUIDS

(71) Applicants: SAUDI ARABIAN OIL COMPANY, Dhahran (SA); KING ABDULLAH UNIVERSITY OF SCIENCE AND TECHNOLOGY, Thuwal (SA)

(72) Inventors: Adrian Cesar CAVAZOS SEPULVEDA, Nuevo Leon (MX); Mani SARATHY, Thuwal (SA); Shashank Sakleshpur NAGARAJA, Thuwal (SA); Manuel Monge PALACIOS, Thuwal (SA)

(73) Assignees: SAUDI ARABIAN OIL COMPANY, Dhahran (SA); KING ABDULLAH UNIVERSITY OF SCIENCE AND TECHNOLOGY, Thuwal (SA)

(21) Appl. No.: 18/328,951

(22) Filed: Jun. 5, 2023

(51) Int. Cl. B01D 53/14; B01J 35/06; B01J 38/00

(52) U.S. Cl. CPC B01D 53/1481; B01D 53/1425; B01D 53/1493; B01J 35/59; B01J 38/00

(57) ABSTRACT

Sulfur species may be processed using an ionic liquid, a deep eutectic solvent, or a combination of both. An example of a method of such processing may include: supplying a first reaction medium including an iodine species and a first catalyst, wherein the first catalyst includes a first deep eutectic solvent, a first ionic liquid, or a first mixture of both; contacting the reaction medium with a first sulfur species, wherein the first sulfur species includes hydrogen sulfide, a sulfur-containing hydrocarbon, or any combination thereof; and reacting the first sulfur species with the reaction medium to produce a second sulfur species, hydrogen iodide, or a combination thereof.

### FIELD OF THE DISCLOSURE

The present disclosure relates generally to chemicals processing and, more particularly, to processing of sulfur species with deep eutectic solvents and/or ionic liquids.

### BACKGROUND OF THE DISCLOSURE

Deep eutectic solvents (DES) and ionic liquids (ILs) are a class of liquids that comprise electrically charged species or ions. Deep eutectic solvents are typically solutions of acids and bases forming a eutectic mixture, allowing for reactions therein due to the presence of hydrogen bond donors and hydrogen bond acceptors. Ionic liquids, meanwhile, generally comprise a mixture of discrete salts that form a liquid reaction medium.

The properties of deep eutectic solvents and ionic liquids have enabled their use for a variety of industrial purposes, including as catalysts and as stimuli responsive materials. The electrically charged nature (due to the presence of ions or charged species therein) of DES and ILs allows for a large thermal operating window due to the lowered vapor pressure of said liquids. Ionic liquids may further include zwitterionic liquids (ZILs), wherein individual molecules of salts within the reaction medium each comprise both positive and negative regions.

Hydrogen is an emerging clean fuel source with potential to power energy storage, electrical production, vehicle propulsion, and other applications. Hydrogen can be converted to usable energy (including electrical energy) with low or no emissions using technologies such as fuel cells where the product is water.

Methane derived from natural gas is the current conventional source for hydrogen production. Conventional methods of producing hydrogen include steam methane reforming (SMR), autothermal methane reforming (ATR), and partial oxidation of methane (POM). SMR, ATR and POM have a primary disadvantage of high CO₂ emissions that negate the clean-burning advantages of using hydrogen as a fuel source. Additional disadvantages of conventional hydrogen production methods include high energy consumption, high cost, low reaction efficiency, low process stability, and low efficiency of catalyst.

Sulfur species such as, for example, hydrogen sulfide (H₂S) and sulfur dioxide (SO₂) are conventionally regarded a toxic and corrosive compounds, and can be byproducts of many petroleum-refining processes. Conventionally, H₂S waste is generally treated through the standard Claus Process, through which H₂S is converted to water and sulfur via a sulfur dioxide (SO₂) intermediate at high temperatures. Although the Claus Process can be highly efficient, residues (including H₂S residue) and impurities often remain and burn to form SO₂. SO₂ itself is hazardous and conventional separation and disposal of SO₂ may generate additional processing and cost and potentially have significant toxic emissions.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

A first nonlimiting method of the present disclosure includes: supplying a first reaction medium comprising an iodine species and a first catalyst, wherein the first catalyst comprises a first deep eutectic solvent, a first ionic liquid, or a first mixture of both; contacting the reaction medium with a first sulfur species, wherein the first sulfur species comprises hydrogen sulfide, a sulfur-containing hydrocarbon, or any combination thereof; and reacting the first sulfur species with the reaction medium to produce a second sulfur species, hydrogen iodide, or a combination thereof.

A second nonlimiting method of the present disclosure includes: supplying a first reaction medium comprising an iodine species and a first catalyst, wherein the first catalyst comprises a first deep eutectic solvent, a first ionic liquid, or a first mixture of both; contacting the reaction medium with a first sulfur species, wherein the first sulfur species comprises hydrogen sulfide; reacting the first sulfur species with the reaction medium to produce dioxide second sulfur species and hydrogen iodide; dispersing an aqueous fluid in the first reaction medium; decreasing the solubility of the second sulfur species in the first reaction medium with the dispersed aqueous fluid; and removing the second sulfur species from the first reaction medium.

A nonlimiting system of the present disclosure includes: a reaction chamber; a first reaction medium contained within the reaction chamber, wherein the first reaction medium comprises an iodine species and a first catalyst, and wherein the first catalyst comprises a first deep eutectic solvent, a first ionic liquid, or a first mixture of both; and a first sulfur species, wherein the first sulfur species is provided to the reaction chamber, wherein the first sulfur species comprises hydrogen sulfide, and wherein the reaction of the first sulfur species with the first reaction medium produces a second sulfur species, hydrogen iodide, or a combination thereof.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a diagram of a nonlimiting example method according to the present disclosure.

FIG. 2 is a diagram of a second nonlimiting example method according to the present disclosure.

FIG. 3 is a diagram of a nonlimiting example system according to the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate chemicals processing and, more particularly, to processing of sulfur species with deep eutectic solvents and/or ionic liquids.

The present disclosure includes methods and systems for processing of sulfur species (e.g., H₂S, SO₂). As described, conventional sulfur species processing may require significant cost and produce toxic emissions. The present disclosure allows for processing of sulfur species in a sustainable manner, and, additionally, potentially generating a value-added hydrogen product. Furthermore, the use of ionic liquids (ILs), deep eutectic solvents (DES), or a combination thereof as a catalyst allows for such cost savings through efficient liquid-phase processing of sulfur species. Additionally, the present disclosure may allow for processing of streams including sulfur species with lower concentrations of SO₂, H₂S, or both, including, for example, processing tail gas from a carbon black production process. The synergistic use of iodine species in the reaction medium along with the catalyst allows for efficient reaction and cyclical regeneration and recycling of the catalyst and iodine. Such recycling minimizes waste and reduces cost, further contributing to the sustainability of the methods of the present disclosure.

The present disclosure includes methods wherein sulfur species are reacted by use of a catalyst (e.g., a deep eutectic solvent, an ionic liquid, or a combination thereof) to produce valuable products including hydrogen.

Without being bound by theory, a sulfur species (e.g., H₂S) processed according to the present disclosure may undergo reaction with an iodine species to produce elemental sulfur and hydrogen iodide (HI), the reaction being catalyzed by a catalyst described herein. Equation (1) below shows a nonlimiting example reaction between H₂S and diatomic iodine (I₂). The HI may then be further processed as described below.

$$I 2 = H 2 S \to 2 HI + S \qquad Equation ( 1 )$$

Continuing to be not bound by theory, a sulfur species may alternatively be oxidized according to the present disclosure, wherein oxidizing is catalyzed by catalysts of the present disclosure. Equation (2) below shows a nonlimiting example reaction of H₂S being oxidized. The oxygen required may be supplied by ambient air, may be found in a reaction medium, or a combination thereof.

$$2 {H}_{2} S + 3 {O}_{2} \to 2 {H}_{2} O + 2 {SO}_{2} \qquad Equation ( 2 )$$

The HI produced may, as described above, subsequently be processed further by a catalyst according to the present disclosure. Without being bound by theory, the catalyst may allow for reaction of the HI such that an iodine species is regenerated and hydrogen gas is produced. A nonlimiting example equation is shown below in Equation (3).

$$2 HI \to {H}_{2} + {I}_{2} \qquad Equation ( 3 )$$

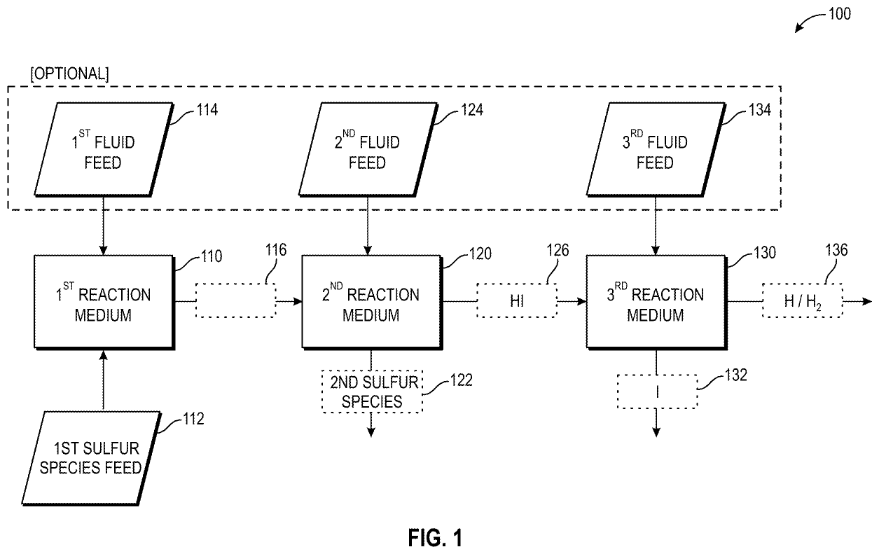

A diagram depicting a nonlimiting example method of the present disclosure is shown in FIG. 1. Method 100 includes wherein first reaction medium 110 is supplied with a first sulfur species (e.g., H₂S) feed 112 and, optionally, supplied with fluid feed 114 comprising an aqueous fluid. In first reaction medium 110, reaction occurs wherein the first sulfur species is catalyzed by a catalyst and is oxidized to produce a stream 116 comprising HI and a second sulfur species. It should be noted that stream 116 may, optionally, be separated into two streams: a gaseous stream comprising the sulfur species (e.g., SO₂) and a liquid stream comprising HI. A second reaction medium 120 is supplied with the feed 116. In the second reaction medium 120, the second sulfur species is sequestered 122 and HI is separated (as shown by arrow 126) from the second sulfur species. The second reaction medium 120 may additionally be optionally supplied with a second fluid feed 124 comprising an aqueous fluid. The HI stream 126 is passed to a third reaction medium 130, wherein the iodine species may be separated (as shown by arrow 132), while the hydrogen is separated (as shown by arrow 136) for further use. The third reaction medium 130 may additionally be optionally supplied with a third fluid feed 134 comprising an aqueous fluid.

The addition of fluid feed comprising an aqueous fluid to the first reaction medium, the second reaction medium, the third reaction medium, or any combination thereof may serve functions including, but not limited to, an additional solvent, to drive a reaction to one equilibrium, the like, or any combination thereof. As a nonlimiting example, additional aqueous fluid may reduce the overall solubility of sulfur species (e.g., SO₂) in a reaction medium, but would not reduce significantly alter HI solubility (as HI solubility in water is about 2450 g/L, while that of SO₂ is 2.51 g/L). This would allow for sulfur species (e.g., SO₂) to fall out of solution and to escape from the reaction medium, allowing the sulfur species (e.g., SO₂) to be sequestered. It should be noted that the fluid feeds may additionally comprise non-aqueous components (e.g., a hydrocarbon, non-aqueous ionic liquids, non-aqueous deep eutectic solvents, the like, or any combination thereof).

It should be noted that use of the second reaction medium and reaction therein, as well as use of the third reaction medium and reaction therein may each be optional, and methods and systems according to the present disclosure may include either, neither, or both. Furthermore, it should be noted that, optionally, in some embodiments, the first reaction medium and second reaction medium may be combined together to form a single physical reaction medium that functions as a first reaction medium and a second reaction medium. Additionally, the present disclosure may include recycling the second reaction medium, the third reaction medium, or a combination thereof, including the catalysts therein so as to re-form the first reaction medium and the catalyst therein. Recycling may, for example, include steps such as addition of iodine species, removal of fluid, or a combination thereof. Following recycling, the processes of the first reaction medium described above may occur with the recycled reaction medium.

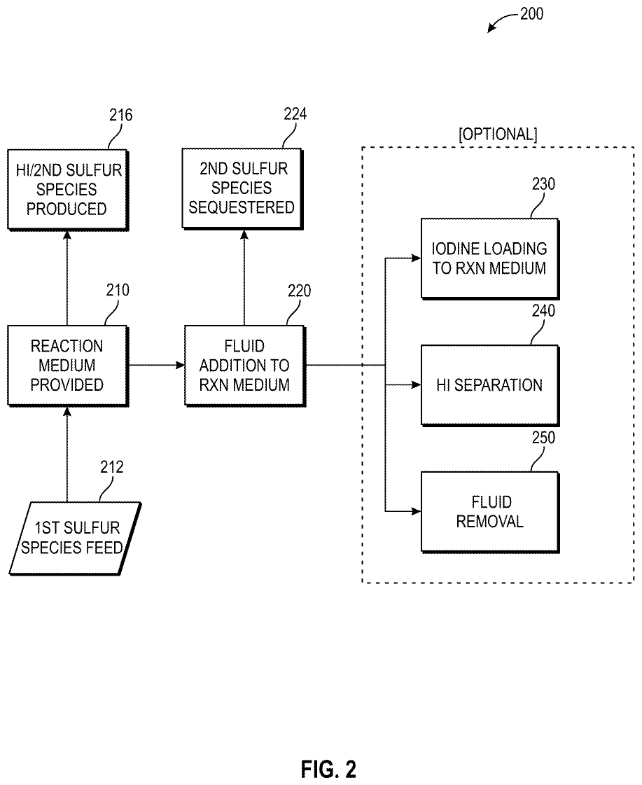

A diagram of a second nonlimiting example method of the present disclosure is shown in FIG. 2. Method 200 includes wherein a reaction medium is provided 210. A first sulfur species (e.g., H₂S) feed may be supplied 212 to the reaction medium, and from the reaction medium, HI, a second sulfur species (e.g., SO₂), or both may be produced 216. Subsequently, fluid may be added to the reaction medium 220, and the second sulfur species (e.g., SO₂) may be sequestered from the reaction medium 224 through being released. Furthermore, optionally, iodine may be loaded or removed/recovered 230 to the reaction medium to serve in the reactions taking place. Additionally, optionally, HI may be separated out 240 of the reaction medium through any suitable means, including conversion to hydrogen gas and iodine. Furthermore, optionally, the aqueous fluid may be removed 250 from the reaction medium. The method may include recycling the reaction medium so as to form a recycled reaction medium. Recycling may occur through any process including those described above in reference to FIG. 1. For example, the additional loading of iodine species to the reaction medium may serve to recycle the reaction medium.

### Sulfur Species

“Sulfur species,” as used herein may refer to any sulfur compound impurity present in hydrocarbon processing operations; examples of sulfur species may include, but are not limited to, sulfur, a sulfur oxide (e.g., sulfur dioxide (SO₂), sulfur trioxide (SO₃), sulfur monoxide (SO), disulfur dioxide (S2O2), S₇O₂, S₆O₂, the like, or any combination thereof), hydrogen sulfide (H₂S), a polysulfane (H₂Sₙ), a sulfur-containing hydrocarbon, a sulfur-based ion (e.g., sulfate (SO₄²⁻), sulfite (SO₃⁻²), bisulfide (HS⁻), a sulfur-based radical (e.g., an HS radical, the like, or any combination thereof) the like, or any combination thereof), the like, or any combination thereof.

The concentration of sulfur species in a stream supplying a reaction medium may be any suitable concentration, including lower concentrations such as those from a tail gas stream. The concentration that sulfur species may be supplied at may be from 0.001 wt % to 100 wt % (or 0.001 wt % to 99.99 wt %, or 0.1 wt % to 99 wt %, or 1 wt % to 99 wt %, or 1 wt % to 50 wt %, or 1 wt % to 25 wt %, or 25 wt % to 99 wt %, or 25 wt % to 75 wt %).

Sulfur species may be at least partially dissolved in the reaction medium, including within the catalyst of the reaction medium.

### Reaction Medium

The reaction medium (e.g., a first reaction medium, second reaction medium, a third reaction medium, the like) may comprise a catalyst and an iodine species. The catalyst may be an ionic liquid, a deep eutectic solvent, metal, metal oxide, or a combination thereof. The individual species (e.g., anions, cations, hydrogen bond donors, hydrogen bond acceptors, the like, and combinations thereof) of the catalyst may comprise: 1-Butyl-3-methylimidazolium (Bmim), 1-carboxyethyl-3-methylimidazolium, C1-C30 1-alkyl-3-methylimidazolium (Cmim), 1,3-dimethylimidazolium (Mmim), N-methylimidazole (Mim), ferric ethylenediaminetetraacetic acid (Fe(EDTA)), ethylenediaminetetraacetic acid (EDTA), FeCl₃, FeCl₄, LiCl, NH₄Al(SO₄)₂, NH₄Cl, NH₄I, Al(NO₃)₃, AlCl, K₂CO₃, CrCl₃, ZnCl₂, SnCl₂, Et₃NHCl, Et₃NHCl, CuCl₂, CoCl₂, MgCl₂ NaCl, KCr(SO₄)₂ methyltriphenylphosphonium iodide, a multiple substituent group (e.g., di, tri, tetra, dodecyltri, hexadecyltri, phenyltri, benzyltri, vinylbenzyl, the like), C₁-C₄ (e.g., methyl, ethyl, propyl, butyl, the like) ammonium halide (e.g., bromide, chloride, iodide, the like), a C₁-C₄ (e.g., methyl, ethyl, propyl, butyl, the like) triphosphonium halide (e.g., bromide, chloride, iodide, the like), 1,3-dithiane, 1,2-diiodo-3,4,5,6-tetrafluorobenzene, 1,3,5-trifluoro-2,4,6-triiodobenzene, lithium bis[(trifluoromethyl)sulfonyl]imide, N-methylacetamide, ethylene glycol (e.g., polyethylene glycol, triethylene glycol, diethylene glycol, the like), glycerol, (-/methyl/ethyl/propyl) a methanesulfonate (e.g., a methanesulfonate ion, methyl methanesulfonate, ethyl methanesulfonate, propyl methanesulfonate, the like), sulfolane, a choline salt (e.g., choline chloride, choline iodide, choline acetate, choline fluoride, choline nitrate, the like), lactic acid, glucose, fructose, saccarose, sucrose, raffinose, maltose, mannitol, lactose, sorbitol, acetic acid, resorcinol, guaiacol, cardanol, caprolactam, propionic acid, oxalic acid, phenylacetic acid, malonic acid, malic acid, xylitol, xylose, urea, glycine, 1,4-butanediol, 2,2,2,-trifluoroacetamide, acetamide, imidazole, 1-methylurea, citric acid, dimethyl urea, phenylacetic acid, betaine alanine, histidine, proline, oxalic acid, 4-oxopentanoic acid, phenylacetic acid, phenylpropionic acid, glutaric acid, glycolic acid, levulinic acid, itaconic acid, tartaric acid, phytic acid, sulfuric acid, succinic acid, phenylpropanoic acid, SO₂, SO₃, p-toluenesulfonic acid, C1-C50 carboxylic acids (e.g., formic acid, acetic acid, the like), an oxidizing ionic liquid, an oxidizing deep eutectic solvent, metals (e.g., transition metals, noble metals, rare earth metals, actinides, the like), metal oxides, a halogen (e.g., a halogen ion), an amine compound, a phosphonium compound, a sulfonated compound, the like, or combinations thereof. Any of the above species may be in any suitable ionic form (e.g., cation, anion) or hydrogen bond acceptor form or hydrogen bond donor form.

The catalyst may further include a catalyst support (e.g., a metallic support, a non-metallic support, the like, or any combination thereof). The catalyst may comprise supported ionic liquids (e.g., a supported ionic liquid membrane), supported deep eutectic solvents on a membrane, or a combination thereof. Said membrane may exist in any suitable configuration including, but not limited to, within the reaction medium, affixed to a reaction chamber containing the reaction medium therein, the like, or any combination thereof.

The iodine species may comprise iodide, diiodide, triiodide, diatomic iodine, or any combination thereof. It should be noted that the iodine species refers general to a plurality of iodine molecules that may be in ionic form. The iodine species may be at least partially dissolved within the catalyst. It should be noted that the iodine species may form the base of an ionic liquid, deep eutectic solvent, or a combination thereof in accordance with the present disclosure. A concentration of the iodine species in the reaction medium, based on the total mass of the reaction medium, may be from 50 ppb to 60 wt % (or 10 ppm to 25 wt %, or 100 ppm to 20 wt %, or 100 ppm to 10 wt %, or 1 ppm to 10,000 ppm, or 10 ppm to 10,000 ppm, or 100 ppm to 10,000 ppm, or 1,000 ppm to 10,000 ppm, or 10,000 ppm to 25 wt %, or 2 wt % to 25 wt %, or 5 wt % to 25 wt %, or 10 wt % to 25 wt %).

The reaction medium may further comprise an aqueous fluid. The aqueous fluid may comprise any suitable aqueous fluid including, but not limited to, water, brine, produced water, flowback water, brackish water, fresh water, waste water, sea water, mineral water, the like, or any combination thereof. The reaction medium may comprise aqueous fluid from 0 wt % to 99 wt % (or 0.01 wt % to 99 wt %, or 0.1 wt % to 99 wt %, or 1 wt % to 99 wt %, or 1 wt % to 90 wt %, or 1 wt % to 75 wt %, or 25 wt % to 75 wt %, or 1 wt % to 25 wt %, or 1 wt % to 50 wt %, or 10 wt % to 40 wt %), based on the total weight of the reaction medium. The aqueous fluid may be dispersed in the reaction medium. The dispersed aqueous fluid may form a solution. The aqueous fluid may be at least partially dissolved in the catalyst (e.g., wherein the reaction medium comprises 5 wt % aqueous fluid). The catalyst may be at least partially dissolved in the aqueous fluid (e.g., wherein the reaction medium comprises 95 wt % aqueous fluid). “Dissolved” and grammatical variants thereof, as used herein, refers to a solute forming a complete solution with a solvent, wherein the solute becomes completely enveloped by solvent so as to form a fully liquid solution. The aqueous fluid may exist as a layer substantially separate from the reaction medium, including, but not limited to, for example, a layer on top of the reaction medium (e.g., floating on the reaction medium).

The reaction medium may further comprise a hydrocarbon (e.g., a petroleum product (e.g., hexane, the like, or any combination thereof). The reaction medium may comprise the hydrocarbon from 0 wt % to 99 wt % (or 0.01 wt % to 99 wt %, or 0.1 wt % to 99 wt %, or 1 wt % to 99 wt %, or 1 wt % to 90 wt %, or 1 wt % to 75 wt %, or 25 wt % to 75 wt %, or 1 wt % to 25 wt %, or 1 wt % to 50 wt %, or 10 wt % to 40 wt %), based on the total weight of the reaction medium. The hydrocarbon may be dispersed in the reaction medium. The dispersed hydrocarbon may form a solution. The hydrocarbon may be at least partially dissolved in the catalyst (e.g., wherein the reaction medium comprises 5 wt % hydrocarbon). The catalyst may be at least partially dissolved in the hydrocarbon (e.g., wherein the reaction medium comprises 95 wt % hydrocarbon). The hydrocarbon may exist as a layer substantially separate from the reaction medium, including, but not limited to, for example, a layer on top of the reaction medium (e.g., floating on the reaction medium).

The reaction medium may further comprise a surfactant. The surfactant may comprise any suitable surfactant. Example suitable surfactants may include, but are not limited to, betaines, alkali metal alkylene acetates, sultaines, ether carboxylates, surface active ionic liquids, the like, or any combination thereof. With or without a surfactant, the reaction medium may form an emulsion. When formed, said emulsion may comprise a microemulsion or a nanoemulsion. As used herein, “microemulsion” refers to an emulsion with particles that generally have an approximate average particle size from 1 μm (micrometers) to 10 μm, while a “nanoemulsion” refers to an emulsion with particles that generally have an approximate average particle size from 10 nm (nanometers) to 10,000 nm, including from 10 nm to 1000 nm. It should be noted that microemulsions and nanoemulsions may refer to the same type of emulsion, depending on the particle size (e.g., in an overlapping size range between 1 μm to 10 μm). Emulsions of the present disclosure may have an average particle size ranging from 50 nm to 100,000 nm (or 50 nm to 10,000 nm, or 50 nm to 1000 nm, or 50 nm to 500 nm). Emulsion particle sizes outside the aforementioned ranges are additionally contemplated.

The reaction medium may further comprise one or more additives known in the art of chemical processing to achieve one or more desired functions (e.g., in addition to the reactive functions previously described), provided that the one or more additives do not adversely affect the reactive function of the reaction medium described herein. Examples of the one or more additives may include, but are not limited to, a polymer, an antioxidant, a solvent, a diluent, a pigment, a rheology modifier, a corrosion inhibitor, a pH modifier, a scale inhibitor, a stabilizer, a chelating agent, a friction reducer, an enzyme, a resin, a salt, a fiber, a marker, the like, or any combination thereof.

### Systems

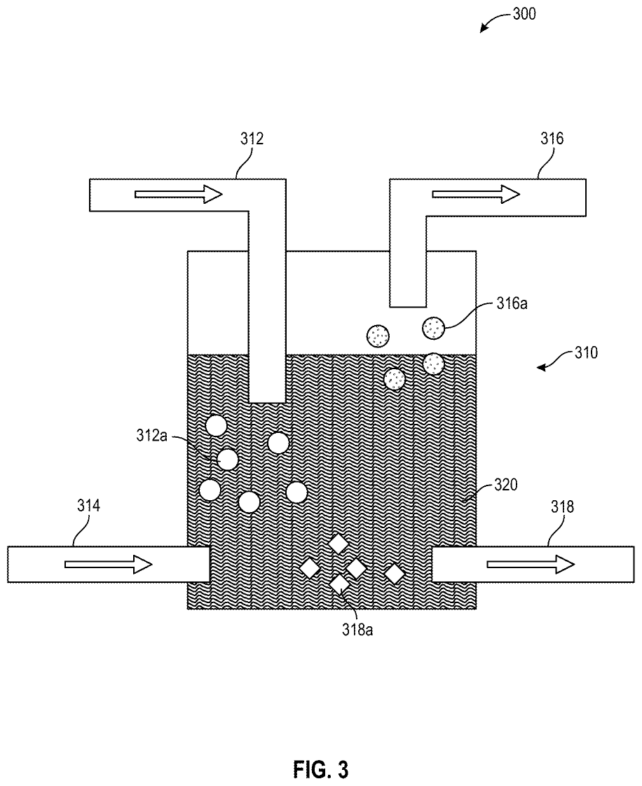

Systems of the present disclosure may comprise a reaction chamber with necessary features so as to carry out methods (including catalyzed reactions) described herein. FIG. 3 shows a nonlimiting example system according to the present disclosure. System 300 shows a reaction chamber 310 containing reaction medium 320 therein. The reaction chamber 310 may have a gaseous inlet 312 for input of sulfur species 312a, as well as a liquid inlet 314 for input of liquid species to the reaction medium 320 (e.g., catalyst, aqueous fluid, the like). The reaction chamber 310 may have a gaseous outlet 316 for output of gaseous reaction products 316a (e.g., sulfur dioxide, oxygen, the like), as well as a liquid outlet 318 for output of liquid from the reaction medium 320. It should be noted that liquid outlet 318 may additionally be utilized for outputting solid precipitate 318a (e.g., elemental sulfur) from the reaction medium 320.

It should be noted that methods of the present disclosure (e.g., nonlimiting example method illustrated in FIG. 1 or FIG. 2) may each be carried out in a singular reaction chamber or more than one reaction chambers (e.g., two or more reaction chambers, three or more reaction chambers, the like).

It additionally should be noted that methods of the present disclosure may include operation of reaction chambers described herein in any suitable manner, including any suitable configuration (e.g., in parallel, in series, the like, or a combination thereof) and including any suitable operational fashion (e.g., a continuous fashion, a batch-wise fashion, the like, or a combination thereof).

For the purpose of these simplified schematic illustrations and description, there may be additional valves, lines, pumps, sensors, controllers, wires, and the like that are customarily employed in chemical processing operations that are well known to those of ordinary skill in the art that are not shown.

### Additional Embodiments

Embodiment 1. A method comprising: supplying a first reaction medium comprising an iodine species and a first catalyst, wherein the first catalyst comprises a first deep eutectic solvent, a first ionic liquid, or a first mixture of both; contacting the reaction medium with a first sulfur species, wherein the first sulfur species comprises hydrogen sulfide, a sulfur-containing hydrocarbon, or any combination thereof; and reacting the first sulfur species with the reaction medium to produce a second sulfur species, hydrogen iodide, or a combination thereof.

Embodiment 2. The method of Embodiment 1, wherein the first catalyst comprises 1-Butyl-3-methylimidazolium (Bmim), 1-carboxyethyl-3-methylimidazolium, C1-C30 1-alkyl-3-methylimidazolium (Cmim), 1,3-dimethylimidazolium (Mmim), N-methylimidazole (Mim), ferric ethylenediaminetetraacetic acid (Fe(EDTA)), ethylenediaminetetraacetic acid (EDTA), FeCl₃, FeCl₄, LiCl, NH₄Al(SO₄)₂, NH₄Cl, NH₄I, Al(NO₃)₃, AlCl, K₂CO₃, CrCl₃, ZnCl₂, SnCl₂, Et₃NHCl, Et₃NHCl, CuCl₂, CoCl₂, MgCl₂ NaCl, KCr(SO₄)₂ methyltriphenylphosphonium iodide, a multiple substituent group C1-C4 ammonium halide, a C1-C4 triphosphonium halide, 1,3-dithiane, 1,2-diiodo-3,4,5,6-tetrafluorobenzene, 1,3,5-trifluoro-2,4,6-triiodobenzene, lithium bis[(trifluoromethyl)sulfonyl]imide, N-methylacetamide, ethylene glycol, glycerol, a methanesulfonate, sulfolane, a choline salt, lactic acid, glucose, fructose, saccarose, sucrose, raffinose, maltose, mannitol, lactose, sorbitol, acetic acid, resorcinol, guaiacol, cardanol, caprolactam, propionic acid, oxalic acid, phenylacetic acid, malonic acid, malic acid, xylitol, xylose, urea, glycine, 1,4-butanediol, 2,2,2,-trifluoroacetamide, acetamide, imidazole, 1-methylurea, citric acid, dimethyl urea, phenylacetic acid, betaine alanine, histidine, proline, oxalic acid, 4-oxopentanoic acid, phenylacetic acid, phenylpropionic acid, glutaric acid, glycolic acid, levulinic acid, itaconic acid, tartaric acid, phytic acid, sulfuric acid, succinic acid, phenylpropanoic acid, SO₂, SO₃, p-toluenesulfonic acid, an oxidizing ionic liquid, an oxidizing deep eutectic solvent, a C1-C50 carboxylic acid, a metal, a metal oxide, a halogen, an amine compound, a phosphonium compound, a sulfonated compound, or any combination thereof.

Embodiment 3. The method of Embodiment 1 or 2, wherein the first catalyst comprises supported ionic liquids on a membrane, a supported deep eutectic solvent on a membrane, or a combination thereof.

Embodiment 4. The method of any one of Embodiments 1-3, wherein the first reaction medium further comprises a fluid, the fluid comprising an aqueous fluid, a hydrocarbon, or any combination thereof.

Embodiment 5. The method of Embodiment 4, wherein the fluid is dissolved within the first catalyst.

Embodiment 6. The method of Embodiment 4, wherein the fluid forms an emulsion in the reaction medium.

Embodiment 7. The method of any one of Embodiments 1-6, wherein the first reaction medium floats on an aqueous solution, and wherein the first sulfur species contacts the aqueous solution prior to contacting the first reaction medium.

Embodiment 8. The method of any one of Embodiments 1-4, wherein the iodine species is, at least partially, dissolved in the first catalyst.

Embodiment 9. The method of any one of Embodiments 1-4, wherein the first sulfur species is, at least partially, dissolved in the first reaction medium.

Embodiment 10. The method of any one of Embodiments 1-9, further comprising: contacting the hydrogen iodide, the second sulfur species or both with a second reaction medium comprising a second catalyst, wherein the second catalyst comprises a second deep eutectic solvent, a second ionic liquid, or a second mixture of both; separating the hydrogen iodide from the second sulfur species using the second catalyst; and sequestering the second sulfur species from the hydrogen iodide.

Embodiment 11. The method of Embodiment 10, further comprising: dispersing an aqueous fluid in the second reaction medium; decreasing the solubility of the second sulfur species in the second reaction medium with the dispersed aqueous fluid; and removing the second sulfur species from the second reaction medium.

Embodiment 12. The method of any one of Embodiments 1-11, further comprising: contacting the hydrogen iodide with a third reaction medium comprising a third catalyst, wherein the third catalyst comprises a third deep eutectic solvent, a third ionic liquid, or a third mixture of both; separating hydrogen gas from the hydrogen iodide using the third catalyst; and sequestering iodine from the hydrogen iodide using the third catalyst.

Embodiment 13. The method of Embodiment 12, further comprising: recycling the second catalyst, the third catalyst so as to re-form the first catalyst; and reacting the first sulfur species with the recycled first catalyst to produce the second sulfur species, hydrogen iodide, or a combination thereof.

Embodiment 14. A method comprising: supplying a first reaction medium comprising an iodine species and a first catalyst, wherein the first catalyst comprises a first deep eutectic solvent, a first ionic liquid, or a first mixture of both; contacting the reaction medium with a first sulfur species, wherein the first sulfur species comprises hydrogen sulfide; reacting the first sulfur species with the reaction medium to produce dioxide second sulfur species and hydrogen iodide; dispersing an aqueous fluid in the first reaction medium; decreasing the solubility of the second sulfur species in the first reaction medium with the dispersed aqueous fluid; and removing the second sulfur species from the first reaction medium.

Embodiment 15. The method of Embodiment 14, further comprising separating the hydrogen iodide from the first reaction medium.

Embodiment 16. The method of Embodiment 15, further comprising: loading an additional iodine species to the reaction medium so as to recycle the first reaction medium to a recycled reaction medium; and reacting the first sulfur species with the recycled reaction medium to produce the second sulfur species, hydrogen iodide, or a combination thereof.

Embodiment 17. A system comprising: a reaction chamber; a first reaction medium contained within the reaction chamber, wherein the first reaction medium comprises an iodine species and a first catalyst, and wherein the first catalyst comprises a first deep eutectic solvent, a first ionic liquid, or a first mixture of both; and a first sulfur species, wherein the first sulfur species is provided to the reaction chamber, wherein the first sulfur species comprises hydrogen sulfide, and wherein the reaction of the first sulfur species with the first reaction medium produces a second sulfur species, hydrogen iodide, or a combination thereof.

Embodiment 18. The system of claim 17, wherein the first catalyst comprises 1-Butyl-3-methylimidazolium (Bmim), 1-carboxyethyl-3-methylimidazolium, C1-C30 1-alkyl-3-methylimidazolium (Cmim), 1,3-dimethylimidazolium (Mmim), N-methylimidazole (Mim), ferric ethylenediaminetetraacetic acid (Fe(EDTA)), ethylenediaminetetraacetic acid (EDTA), FeCl₃, FeCl₄, LiCl, NH₄Al(SO₄)₂, NH₄Cl, NH₄I, Al(NO₃)₃, AlCl, K₂CO₃, CrCl₃, ZnCl₂, SnCl₂, Et₃NHCl, Et₃NHCl, CuCl₂, CoCl₂, MgCl₂ NaCl, KCr(SO₄)₂ methyltriphenylphosphonium iodide, a multiple substituent group C1-C4 ammonium halide, a C1-C4 triphosphonium halide, 1,3-dithiane, 1,2-diiodo-3,4,5,6-tetrafluorobenzene, 1,3,5-trifluoro-2,4,6-triiodobenzene, lithium bis[(trifluoromethyl)sulfonyl]imide, N-methylacetamide, ethylene glycol, glycerol, a methanesulfonate, sulfolane, a choline salt, lactic acid, glucose, fructose, saccarose, sucrose, raffinose, maltose, mannitol, lactose, sorbitol, acetic acid, resorcinol, guaiacol, cardanol, caprolactam, propionic acid, oxalic acid, phenylacetic acid, malonic acid, malic acid, xylitol, xylose, urea, glycine, 1,4-butanediol, 2,2,2,-trifluoroacetamide, acetamide, imidazole, 1-methylurea, citric acid, dimethyl urea, phenylacetic acid, betaine alanine, histidine, proline, oxalic acid, 4-oxopentanoic acid, phenylacetic acid, phenylpropionic acid, glutaric acid, glycolic acid, levulinic acid, itaconic acid, tartaric acid, phytic acid, sulfuric acid, succinic acid, phenylpropanoic acid, SO₂, SO₃, p-toluenesulfonic acid, an oxidizing ionic liquid, an oxidizing deep eutectic solvent, a C1-C50 carboxylic acid, a metal, a metal oxide, a halogen, an amine compound, a phosphonium compound, a sulfonated compound, or any combination thereof.

Embodiment 19. The system of claim 17, wherein the first catalyst comprises supported ionic liquids on a membrane, a supported deep eutectic solvent on a membrane, or a combination thereof.

Embodiment 20. The system of claim 17, wherein the first reaction medium further comprises an aqueous fluid, a hydrocarbon, or any combination thereof.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method comprising:
supplying a first reaction medium comprising an iodine species and a first catalyst, wherein the first catalyst comprises a first deep eutectic solvent, a first ionic liquid, or a first mixture of both;
contacting the reaction medium with a first sulfur species, wherein the first sulfur species comprises hydrogen sulfide, a sulfur-containing hydrocarbon, or any combination thereof; and
reacting the first sulfur species with the reaction medium to produce a second sulfur species, hydrogen iodide, or a combination thereof.

2. The method of claim 1, wherein the first catalyst comprises 1-Butyl-3-methylimidazolium (Bmim), 1-carboxyethyl-3-methylimidazolium, C1-C30 1-alkyl-3-methylimidazolium (Cmim), 1,3-dimethylimidazolium (Mmim), N-methylimidazole (Mim), ferric ethylenediaminetetraacetic acid (Fe(EDTA)), ethylenediaminetetraacetic acid (EDTA), FeCl₃, FeCl₄, LiCl, NH₄Al(SO₄)₂, NH₄Cl, NH₄I, Al(NO₃)₃, AlCl, K₂CO₃, CrCl₃, ZnCl₂, SnCl₂, Et₃NHCl, Et₃NHCl, CuCl₂, CoCl₂, MgCl₂ NaCl, KCr(SO₄)₂ methyltriphenylphosphonium iodide, a multiple substituent group C1-C4 ammonium halide, a C1-C4 triphosphonium halide, 1,3-dithiane, 1,2-diiodo-3,4,5,6-tetrafluorobenzene, 1,3,5-trifluoro-2,4,6-triiodobenzene, lithium bis[(trifluoromethyl)sulfonyl]imide, N-methylacetamide, ethylene glycol, glycerol, a methanesulfonate, sulfolane, a choline salt, lactic acid, glucose, fructose, saccarose, sucrose, raffinose, maltose, mannitol, lactose, sorbitol, acetic acid, resorcinol, guaiacol, cardanol, caprolactam, propionic acid, oxalic acid, phenylacetic acid, malonic acid, malic acid, xylitol, xylose, urea, glycine, 1,4-butanediol, 2,2,2,-trifluoroacetamide, acetamide, imidazole, 1-methylurea, citric acid, dimethyl urea, phenylacetic acid, betaine alanine, histidine, proline, oxalic acid, 4-oxopentanoic acid, phenylacetic acid, phenylpropionic acid, glutaric acid, glycolic acid, levulinic acid, itaconic acid, tartaric acid, phytic acid, sulfuric acid, succinic acid, phenylpropanoic acid, SO₂, SO₃, p-toluenesulfonic acid, an oxidizing ionic liquid, an oxidizing deep eutectic solvent, a C1-C50 carboxylic acid, a metal, a metal oxide, a halogen, an amine compound, a phosphonium compound, a sulfonated compound, or any combination thereof.

3. The method of claim 1, wherein the first catalyst comprises supported ionic liquids on a membrane, a supported deep eutectic solvent on a membrane, or a combination thereof.

4. The method of claim 1, wherein the first reaction medium further comprises a fluid, the fluid comprising an aqueous fluid, a hydrocarbon, or any combination thereof.

5. The method of claim 4, wherein the fluid is dissolved within the first catalyst.

6. The method of claim 4, wherein the fluid forms an emulsion in the reaction medium.

7. The method of claim 1, wherein the first reaction medium floats on an aqueous solution, and wherein the first sulfur species contacts the aqueous solution prior to contacting the first reaction medium.

8. The method of claim 1, wherein the iodine species is, at least partially, dissolved in the first catalyst.

9. The method of claim 1, wherein the first sulfur species is, at least partially, dissolved in the first reaction medium.

10. The method of claim 1, further comprising:
contacting the hydrogen iodide, the second sulfur species or both with a second reaction medium comprising a second catalyst, wherein the second catalyst comprises a second deep eutectic solvent, a second ionic liquid, or a second mixture of both;
separating the hydrogen iodide from the second sulfur species using the second catalyst; and
sequestering the second sulfur species from the hydrogen iodide.

11. The method of claim 10, further comprising:
dispersing an aqueous fluid in the second reaction medium;
decreasing the solubility of the second sulfur species in the second reaction medium with the dispersed aqueous fluid; and
removing the second sulfur species from the second reaction medium.

12. The method of claim 1, further comprising:
contacting the hydrogen iodide with a third reaction medium comprising a third catalyst, wherein the third catalyst comprises a third deep eutectic solvent, a third ionic liquid, or a third mixture of both;
separating hydrogen gas from the hydrogen iodide using the third catalyst; and
sequestering iodine from the hydrogen iodide using the third catalyst.

13. The method of claim 12, further comprising:
recycling the second catalyst, the third catalyst so as to re-form the first catalyst; and
reacting the first sulfur species with the recycled first catalyst to produce the second sulfur species, hydrogen iodide, or a combination thereof.

14. A method comprising:
supplying a first reaction medium comprising an iodine species and a first catalyst, wherein the first catalyst comprises a first deep eutectic solvent, a first ionic liquid, or a first mixture of both;
contacting the reaction medium with a first sulfur species, wherein the first sulfur species comprises hydrogen sulfide;
reacting the first sulfur species with the reaction medium to produce dioxide second sulfur species and hydrogen iodide;
dispersing an aqueous fluid in the first reaction medium;
decreasing the solubility of the second sulfur species in the first reaction medium with the dispersed aqueous fluid; and
removing the second sulfur species from the first reaction medium.

15. The method of claim 14, further comprising separating the hydrogen iodide from the first reaction medium.

16. The method of claim 15, further comprising:
loading an additional iodine species to the reaction medium so as to recycle the first reaction medium to a recycled reaction medium; and
reacting the first sulfur species with the recycled reaction medium to produce the second sulfur species, hydrogen iodide, or a combination thereof.

17. A system comprising:
a reaction chamber;
a first reaction medium contained within the reaction chamber, wherein the first reaction medium comprises an iodine species and a first catalyst, and wherein the first catalyst comprises a first deep eutectic solvent, a first ionic liquid, or a first mixture of both; and
a first sulfur species, wherein the first sulfur species is provided to the reaction chamber, wherein the first sulfur species comprises hydrogen sulfide, and wherein the reaction of the first sulfur species with the first reaction medium produces a second sulfur species, hydrogen iodide, or a combination thereof.

18. The system of claim 17, wherein the first catalyst comprises 1-Butyl-3-methylimidazolium (Bmim), 1-carboxyethyl-3-methylimidazolium, C1-C30 1-alkyl-3-methylimidazolium (Cmim), 1,3-dimethylimidazolium (Mmim), N-methylimidazole (Mim), ferric ethylenediaminetetraacetic acid (Fe(EDTA)), ethylenediaminetetraacetic acid (EDTA), FeCl₃, FeCl₄, LiCl, NH₄Al(SO₄)₂, NH₄Cl, NH₄I, Al(NO₃)₃, AlCl, K₂CO₃, CrCl₃, ZnCl₂, SnCl₂, Et₃NHCl, Et₃NHCl, CuCl₂, CoCl₂, MgCl₂ NaCl, KCr(SO₄)₂ methyltriphenylphosphonium iodide, a multiple substituent group C₁-C₄ ammonium halide, a C1-C4 triphosphonium halide, 1,3-dithiane, 1,2-diiodo-3,4,5,6-tetrafluorobenzene, 1,3,5-trifluoro-2,4,6-triiodobenzene, lithium bis[(trifluoromethyl)sulfonyl]imide, N-methylacetamide, ethylene glycol, glycerol, a methanesulfonate, sulfolane, a choline salt, lactic acid, glucose, fructose, saccarose, sucrose, raffinose, maltose, mannitol, lactose, sorbitol, acetic acid, resorcinol, guaiacol, cardanol, caprolactam, propionic acid, oxalic acid, phenylacetic acid, malonic acid, malic acid, xylitol, xylose, urea, glycine, 1,4-butanediol, 2,2,2,-trifluoroacetamide, acetamide, imidazole, 1-methylurea, citric acid, dimethyl urea, phenylacetic acid, betaine alanine, histidine, proline, oxalic acid, 4-oxopentanoic acid, phenylacetic acid, phenylpropionic acid, glutaric acid, glycolic acid, levulinic acid, itaconic acid, tartaric acid, phytic acid, sulfuric acid, succinic acid, phenylpropanoic acid, SO₂, SO₃, p-toluenesulfonic acid, an oxidizing ionic liquid, an oxidizing deep eutectic solvent, a C1-C50 carboxylic acid, a metal, a metal oxide, a halogen, an amine compound, a phosphonium compound, a sulfonated compound, or any combination thereof.

19. The system of claim 17, wherein the first catalyst comprises supported ionic liquids on a membrane, a supported deep eutectic solvent on a membrane, or a combination thereof.

20. The system of claim 17, wherein the first reaction medium further comprises an aqueous fluid, a hydrocarbon, or any combination thereof.
